(19) United States
(12) Patent Application Publication
(10) Pub. No.: US 2014/0174308 A1
(43) Pub. Date: Jun. 26, 2014

(54) INK WELL LINER FOR A SILKSCREEN FRAME

(71) Applicants: John C. Wright, St. Paris, OH (US); James W. Wright, St. Paris, OH (US)

(72) Inventors: John C. Wright, St. Paris, OH (US); James W. Wright, St. Paris, OH (US)

(21) Appl. No.: 14/138,842

(22) Filed: Dec. 23, 2013

Related U.S. Application Data
(60) Provisional application No. 61/745,663, filed on Dec. 24, 2012.

(51) Int. Cl. B41F 15/34

(52) U.S. Cl. CPC B41F 15/34
USPC 101/126

(57) ABSTRACT

A liner is inserted into the well of a silkscreen printing frame, enabling the printing process to be carried out considerably faster and more efficiently. The liner bridges the interface between the interior periphery of the frame and a screen stencil stretched across the bottom of the frame. The liner includes generally vertical sidewalls disposed adjacent the inner periphery of the frame and an integral inwardly depending base that overlaps the margins of the screen stencil. An adhesive coating on the bottom surface of the liner base securely adheres the liner base to an emulsion layer covering the margins of the screen stencil. The base of the liner is otherwise open so that ink deposited in the well contacts the non-marginal region of the screen stencil, while the liner isolates the ink from the interface between the screen stencil and the inner periphery of the frame.

### RELATED APPLICATIONS

This application claims priority based on the Provisional Patent Application No. 61/745,663, filed Dec. 24, 2012.

### TECHNICAL FIELD

The present invention relates to an apparatus for facilitating the printing step of a conventional silkscreen process.

### BACKGROUND OF THE INVENTION

Silkscreen printing involves a common and well-known process in which ink is transferred onto a substrate such as fabric through a screen stencil that is stretched over and fastened to the base of a closed frame of wood or metal. The frame is oriented so that the screen stencil rests atop the substrate, and the inner periphery of the frame defines an ink well above the screen stencil. A quantity of ink is deposited into the ink well near a wall of the frame, and the ink is spread across the screen stencil with a rubber squeegee to force ink through the screen stencil and onto the substrate.

A problem is encountered in the above-described printing process when the seal between the screen stencil and the frame is imperfect, and some of the ink leaks out of the well at the base of the frame. Ordinarily, this problem is addressed by bridging the interface between the frame and screen stencil with masking tape. However, applying the masking tape is a tedious and time-consuming process because the inner periphery of the frame is typically perpendicular to the screen stencil, requiring the tape to be creased before being applied; and the corners of the well are especially trying because the tape has to cover a three-dimensional surface. Furthermore, the tape must be removed and reapplied with each change in ink color. Accordingly, what is needed is a faster and more effective way of sealing the interface between the screen stencil and the frame.

### SUMMARY OF THE INVENTION

The present invention is directed to a disposable liner for a conventional silkscreen printing apparatus including a rigid frame and a screen stencil stretched over the base of the frame. The liner is inserted into an ink will defined by the inner periphery of the frame and an upper surface of the screen stencil to form an ink barrier between the frame and a non-marginal portion of the screen stencil. The liner has contiguous sidewalls and an inwardly depending base so that when the liner is inserted into the ink well, its sidewalls are disposed adjacent the inner periphery of the frame, and its base lies atop a marginal portion of the screen stencil. The inwardly depending base has a central opening so that ink can be deposited onto the non-marginal portion of the screen stencil in the usual manner. The upper marginal surface of the screen stencil adjacent the frame is coated with an emulsion layer, and when the inwardly depending base of the liner is sealed against the emulsion layer, it bridges the interface between the screen stencil and the frame so that ink deposited onto the non-marginal portion of the screen stencil is physically isolated from the frame. In a preferred configuration, the lower surface of the inwardly depending base—that is, the surface of the liner that contacts and overlaps the marginal portion of the screen stencil—is coated with adhesive material that securely adheres the liner base to the emulsion layer on the marginal portion of the screen stencil. The ink well liner is preferably constructed of thin plastic material so that it is disposable and inexpensive to manufacture, and so that it allows a squeegee to be drawn across the screen stencil in the usual manner.

### BRIEF DESCRIPTION OF THE DRAWINGS

FIG. 1 is a cross-sectional diagram of a conventional silkscreen printing apparatus, along with an ink well liner according to this invention;

FIG. 2 is a cross-sectional view of the ink well liner of FIG. 1 according to a preferred embodiment in which the inwardly depending base of the liner is coated with adhesive material; and

FIG. 3 is a perspective view of the ink well liner of FIG. 1, but without the upper shoulder.

### DESCRIPTION OF THE PREFERRED EMBODIMENT

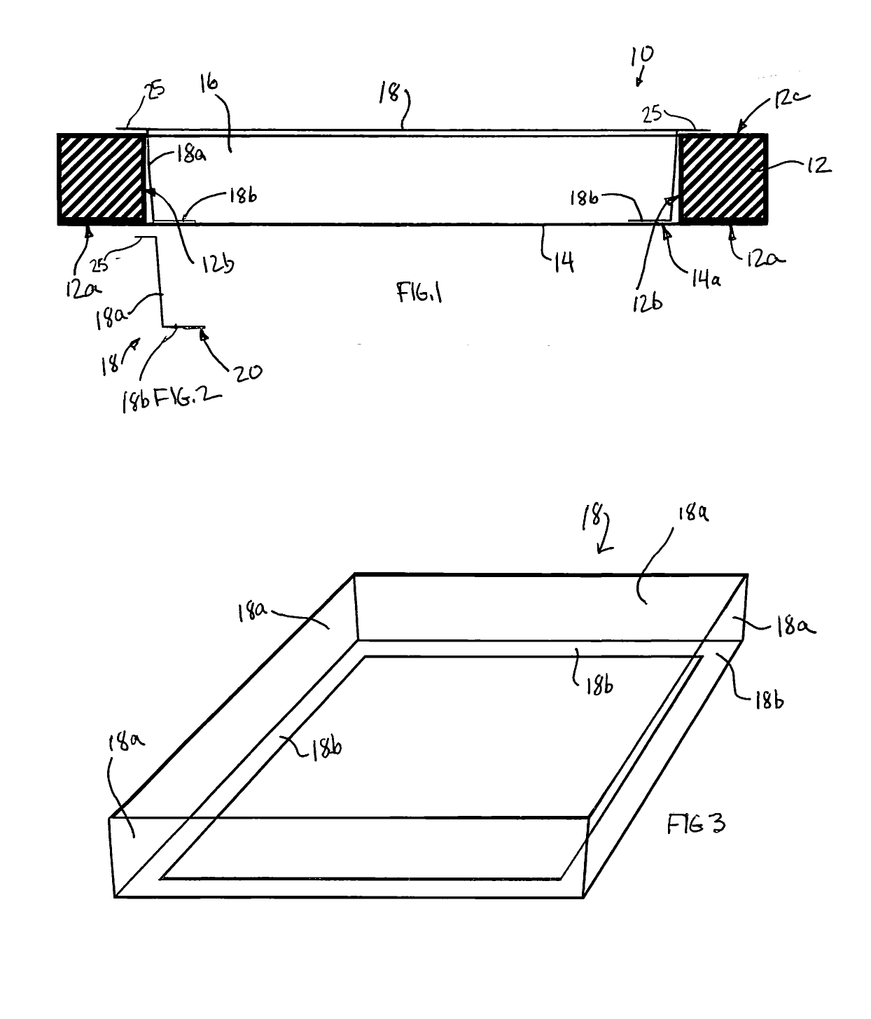

Referring to the drawings, and particularly to FIG. 1, the reference numeral 10 generally designates a silkscreen printing apparatus according to this invention. The conventional portions of the apparatus 10 include a generally rectangular frame 12 (typically constructed of wood or aluminum), and a screen stencil 14 stretched across and fastened to the bottom or base 12a of the frame 12. The screen stencil 14 is typically constructed of polyester screen material coated with a light-sensitive emulsion, and the emulsion is selectively cured and rinsed to form a pattern in the central or non-marginal area 14a of the screen. The cured emulsion remains on the marginal area 14b of the screen and on portions of the non-marginal area 14a so that ink can pass through the non-marginal area 14a in a predefined pattern.

In conventional usage, the frame 12 serves not only to support the screen stencil 14, but also to define a well 16 bounded on the bottom by the screen stencil 14, and on the sides by the inner periphery (i.e., interior sidewalls 12b) of the frame 12. The apparatus 10 is placed atop a fabric or other substrate (not shown) and a quantity of ink is deposited into the well 16 near one of the sidewalls 12b. A squeegee (not shown) is then positioned along the sidewall 12b and drawn across the screen stencil 14 to spread out the ink and force it through the screen stencil 14 (in areas not coated with cured emulsion) and onto the substrate.

According to the present invention, however, an ink well liner 18 is placed in the well 16 and secured to the marginal area 14b of screen stencil 14, whereafter the well 16 is laterally bounded by the liner 18 instead of the frame sidewalls 12b. As best seen in FIGS. 2-3, the ink well liner 18 is of single-piece construction, including a set of four generally vertical sidewalls 18a, and an integral inwardly depending base 18b, the central portion of which is open. When the liner 18 is placed in the well 16, the generally vertical sidewalls 18a are disposed adjacent the interior sidewalls 12b of the frame 12, and the inwardly depending base 18b contacts and overlaps the marginal area 14b of the screen stencil 14. As a result, the liner 18 isolates the ink from frame sidewalls 12b, and the only way that ink can leak out of the well 16 (other than passing through the screen stencil 14) is to seep between the base 18b of liner 18 and the cured emulsion coating on the marginal area 14a of screen stencil 14. In the preferred embodiment of this invention, any such seepage is prevented by a coating of adhesive material 20 on the surface of base 18b that contacts the screen stencil 14. Preferably, the adhesive material 20 is applied to the base 18b of liner 18 at the time of its manufacture, and covered with a strip of silicone paper (not shown) that is removed by the user just prior to insertion of the liner 18 into the well 16. The adhesive material 20 adheres to the emulsion layer on the marginal area 14a of screen stencil 14 to securely fasten the liner base 18b to the screen stencil 14. The adhesive 20 effectively seals the interface between the liner base 18b and the screen stencil 14, preventing seepage of ink there-between. If the adhesive material 20 is not provided, the user may use masking tape to bridge the interface between the liner base 18b and the screen stencil 14; unlike the conventional taping method described above, taping off the liner 18 is quick and easy because the liner base 18b and screen stencil 14 lie virtually in the same plane, and the tape does not have to be creased or cut in unusual shapes prior to its application.

The ink well liner 18 is preferably constructed of thin plastic material, so that it is disposable and inexpensive to manufacture, and so that it doesn't interfere with the operation of the squeegee during the printing process. If desired, the liner 18 may include a shoulder 25 depending outwardly from the top of the sidewalls 18a such that it rests on the top surface 12c of the frame 12 as shown in FIG. 1; but the shoulder 25 is optional because a liner 18 without the shoulder 25 has the advantage of working equally well with frames of different heights.

In summary, the ink well liner 18 of the present invention greatly simplifies and streamlines the silkscreen printing process by eliminating the tedious and time-consuming task of sealing the interface between the screen stencil 14 and the frame 12 with masking tape. Since the liner 18 is simple and inexpensive to manufacture, its cost will not materially add to the cost of the apparatus 10; whereas the savings in time afforded by the liner 18 will significantly reduce the cost of carrying out the printing process.

While the present invention has been described with respect to the illustrated embodiment, it is recognized that numerous modifications and variations in addition to those mentioned herein will occur to those skilled in the art. Accordingly, it is intended that the invention not be limited to the disclosed embodiment, but that it have the full scope permitted by the language of the following claims.

1. Apparatus for silkscreen printing, comprising:
a closed frame having a base and an inner periphery;
a screen stencil stretched over and fastened to the bottom of the frame to define a well above said screen stencil and within the inner periphery of said frame, the screen stencil having a marginal portion within the inner periphery of said frame that is coated with a cured emulsion; and
a liner inserted in said well, said liner having sidewalls adjacent the inner periphery of said frame and an integral inwardly depending base affixed to the cured emulsion on the marginal portion of said screen stencil to define an ink well laterally bounded by the sidewalls of said liner, said base being open in a central region thereof to expose a non-marginal portion of said screen stencil.

2. The apparatus of claim 1, further comprising:
a coating of adhesive material on a surface of said base that faces said screen stencil so as to affix said base to the cured emulsion on the marginal portion of said screen stencil, and thereby seal an interface between said screen stencil and said base.

3. The apparatus of claim 1, where:
said liner is of single piece construction.

4. The apparatus of claim 3, where:
said liner is constructed of plastic material.

5. The apparatus of claim 1, where:
the sidewalls of said liner are generally vertically disposed with respect to said inwardly depending base.

6. The apparatus of claim 1, where:
said liner additionally includes an integral shoulder that depends outwardly from said sidewalls and rests on a top surface of said frame.
